(19) United States
(12) Patent Application Publication
(10) Pub. No.: US 2006/0188184 A1
(43) Pub. Date: Aug. 24, 2006

(54) Housing, fastening device for a housing, and hand-held power tool with a housing

(76) Inventors: Karl Frauhammer, Leinfelden-Echterdingen (DE); Heinz Schnerring, Dettenhausen (DE); Willy Braun, Neustetten (DE); Axel Kuhnle, Freiberg (DE)

Correspondence Address: STRIKER, STRIKER & STENBY, 103 EAST NECK ROAD, HUNTINGTON, NY, 11743, US

(21) Appl. No.: 11/294,900

(22) Filed: Dec. 6, 2005

(30) Foreign Application Priority Data
Feb. 22, 2005 (DE) 10 2005 008037.5

(51) Int. Cl. F16C 33/00

(52) U.S. Cl. 384/91

(57) ABSTRACT

A housing has at least one housing shell enclosing an interior space and having two edges abutting each other at least one butt seam extending axially along a longitudinal axis, and first and second retaining elements provided on either side of said butt seam and acting on a particular side of the at least one housing shell on both sides of the butt seam with a force that is directed substantially radially toward the interior space.

### BACKGROUND OF THE INVENTION

The present invention is related to a housing, a fastening device, and a hand-held power tool with a housing.

It is known that, with hand-held power tools with insertion tools, such as rotary and percussion hammers, the usually metallic transmission housing and a motor housing are enclosed in a plastic housing shell. This plastic housing shell is typically designed with an intermediate-shell construction, the two housing shells being screwed together at a plurality of points. The two front screw eyes of the two housing shells located on the tool-side end in front of the transmission housing and inside the actuating sleeve for the insertion tool holder are difficult to access and require a relatively large amount of installation space.

### SUMMARY OF THE INVENTION

Accordingly, it is an object of the present invention to provide a housing, a fastening device for a housing, and a hand-held power tool with a housing, which avoid the disadvantages of the prior art.

In the present invention the housing, in particular for a hand-held power tool, has at least one housing shell enclosing an interior space, with two edges for closing the housing abutting each other at at least one butt seam extending axially along a longitudinal axis.

It is provided that a first and second retaining means are provided on either side of the butt seam that act on the particular side of the particular housing shell with a force that is directed substantially radially toward the interior space. A connection between housing shells and a closing of the housing can be produced without screws. A hand-held power tool can be shorter in length, since less space must be provided for screw eyes for housing shells. The connection of the housing shells is nevertheless stable and reliable. The housing can preferably be composed of two housing shells. A housing composed of more than two housing shells is feasible, however, that can be easily assembled using the arrangement according to the present invention. A single housing shell is also feasible, when appropriately flexible wall material is used, the butt seam of which can be closed in the manner according to the present invention.

In a favorable embodiment, the housing shells on at least one housing front side are clamped with retaining means located on either side of the butt seam, the retaining means pointing from the particular housing shell toward the interior space. The edges of the butt seam or butt seams are held together tightly by the force acting toward the interior space.

The retaining means advantageously bear against a housing outer side in a non-positive and/or form-fit manner, preferably in a sliding fit. It is also feasible that the retaining means inside the housing engage in suitable holders of the housing shell(s) and pull them inward.

In a favorable embodiment, the retaining means extend from a bearing sleeve located inside the housing outward toward the housing. The retaining means can be designed, e.g., as cantilevers. The bearing sleeve itself can be secured against rotation via its retaining means fastened to the housing.

A secure connection between the housing shells is possible when at least one retaining means more than the number of axial butt seams is provided. A symmetrical arrangement is particularly favorable when two retaining means are provided for each butt seam, the butt seam being located between the particular pair of retaining means. The retaining means are located as close to the butt seams as possible.

In a favorable embodiment, the edges of the housing shell or housing shells are configured such that they overlap at the butt seams, so that a projection of the one edge lies on a step of the other edge, via which an advantageous seal integrity of the housing can be obtained.

The present invention also relates to a fastening device for a housing, in particular for a hand-held power tool, with at least one housing shell enclosing an interior space, with at least one butt seam of edges extending axially along a longitudinal axis, to close the housing.

It is provided that a bearing sleeve includes radially outwardly extending, hooked or claw-like retaining means located on the circumference of the bearing sleeve at a distance from each other. The retaining means are provided for establishing a non-positive and/or form-fit connection with one or more housing shells when installed. The retaining means can be designed preferably as cantilevers. Retaining hooks can be integrally formed on the cantilevers, and they can have a slight bevel.

The bearing sleeve can be slid preferably on the front side onto the assembled housing shells in a sliding fit. It is possible to fix a bearing sleeve of this type at both ends of the housing and to thereby connect the edges of the housing shells in this manner. It is also possible to provide the bearing sleeve with the retaining means on one side and to provide screwed connections toward the other end of the housing. The bearing sleeve is preferably made of plastic, as are the housing shells.

A circumferential recess is preferably formed on at least one front side of the bearing sleeve that supports spring action of the retaining means. The action of sliding the bearing sleeve on and/or snapping it in place with its retaining means on the housing is simplified.

In a favorable embodiment, a tooth system is provided on an axial end of the bearing sleeve, with which the bearing sleeve, when installed, non-rotatably holds a sintered bearing and/or a pressed-in gasket against a transmission housing or a motor housing.

The present invention is also directed to a hand-held power tool that is drivable in a percussive and/or drilling manner, in particular a rotary hammer and/or chisel hammer, with a transmission housing and/or motor housing enclosed by at least one housing shell of a housing, edges for closing the housing abutting each other at at least one butt seam extending axially along a longitudinal axis.

It is provided that a first and second retaining means are provided on either side of the butt seam that act on the particular side of the particular housing shell with a force that is directed substantially radially toward the interior space. The sides on either side of the butt seam of the at least one housing shell are drawn together in a non-positive and/or form-fit manner and can be connected securely together, resulting in a short overall length. Preferably, two housing shells are provided that, together, form the housing. This results in reduced cost and weight. Assembly and disassembly of the hand-held power tool is simplified.

In a favorable embodiment, the retaining means extend radially from a bearing sleeve toward the housing. The bearing sleeve is flat and takes up little space. The bearing sleeve itself can be secured against rotation via its retaining means fastened to the housing.

In a further favorable embodiment, at least two of the retaining means have distance between each other such that, when installed on a housing front side, at least one of the butt seams is connected with the housing and/or the housing shells in a non-positive and/or form-fit manner.

In a favorable embodiment, the bearing sleeve is non-rotatably supported in the transmission housing and/or on the motor housing. This can be accomplished by the retaining means that bear against the housing in a non-rotatable manner.

The bearing sleeve is preferably connected with a sintered bearing surrounding the transmission housing or the motor housing by engaging in a tooth system on the sintered bearing. As a result, the sintered bearing is also secured such that it is non-rotatable relative to the transmission housing.

Preferably, a sealing ring is pressed into the bearing sleeve on its circumference facing the transmission housing or the motor housing. With the non-rotatable support of the bearing sleeve, the sealing ring is also advantageously situated such that it is non-rotatable. A non-rotatable support of the sealing ring and bearing sleeve is a quality advantage of the hand-held power tool. A high level of quality is thereby made more consistent.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a partial cross-section through a region of a preferred hand-held power tool with a preferred bearing sleeve;

FIG. 2 shows a top view of a preferred bearing sleeve along the line II-II in FIG. 1; and

FIG. 3 is a top view of a detail with a retaining means of the preferred bearing sleeve in FIG. 1.

### DESCRIPTION OF THE PREFERRED EMBODIMENTS

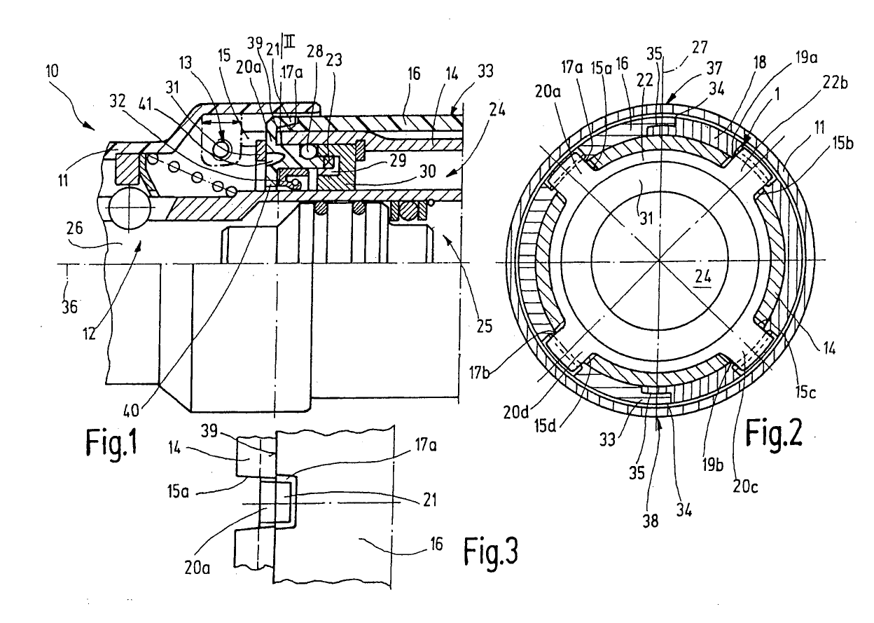

FIG. 1 shows a partial cross section through an area of a preferred hand-held power tool 10 with a preferred bearing sleeve 22 that encloses a transmission designed as an impact mechanism. FIG. 2 shows a top view of the arrangement with bearing sleeve 22 in the region of line 11. FIG. 3 shows a detail of a retaining means 20a in contact with a housing shell 16.

In the front region, hand-held power tool 10 has a typical actuating sleeve 11 for a not-shown insertion tool that can be inserted in a receiving bore 26 and that is lockable using a typical locking mechanism 12. A not-shown transmission 25 designed as an impact mechanism bears in an interior space 24 in a direction of insertion of insertion tool, transmission 25 being enclosed in a typically metallic transmission housing 14.

The multiple-shell housing is formed of two housing shells 16, 18 enclosing interior space 24 and/or transmission housing 14, the housing shells abutting each other with their edges 34, 35 at two butt seams 37, 38 extending axially along a longitudinal axis 36.

Also shown in FIG. 1, as a dash-dotted line, is a top screw eye 13 where a not-shown connecting screw is screwed in to connect the two housing shells 16, 18. Screw eye 13 can be eliminated when housing shells 16,18 are connected according to the present invention using bearing sleeve 22 provided with retaining means 20a, 20b, 20c, 20d. A lower screw eye that is not shown in the Figure can also be eliminated. As a result, the hand-held power tool is shortened longitudinally by a few millimeters, preferably between 10 to 15 mm. The length that is eliminated is indicated with an arrow pointing in both directions.

A first and second retaining means 20a, 20b and 20c, 20d preferably designed as a cantilever are provided on both sides of butt seam 37, 38 of housing shells 16, 18 in the top and bottom region of FIG. 2, the retaining means acting on the particular housing shell 16, 18 with a force that is directed substantially radially toward the interior space 24. Housing shells 16, 18 are configured such that they overlap at butt seams 37, 38. An edge 34 of housing shell 16 designed as a projection can be pressed tightly onto an edge 35 of housing shell 18 designed as a step, and the two housing shells 16,18 can be drawn toward each other when retaining means 20a, 20b, 20c, 20d engage with housing shells 16, 18.

Retaining means 20a, 20b, 20c, 20d configured as cantilever arms extend radially outward from bearing sleeve 22 located inside housing shells 16, 18 toward housing shells 16, 18 and extend through an opening 15a, 15b, 15c, 15d in transmission housing 14 into a segment recess 17a, 17b of housing shell 16 and into a segment recess 19a, 19b of housing shell 18.

Retaining means 20a, 20b, 20c, 20d bear against a housing outer side 40 in a non-positive and/or form-fit manner, as shown in FIG. 1. To this end, bearing sleeve 22 has, e.g., integrally moulded retaining hooks 21a, 21b, 21c, 21d on their retaining means 20a, 20b, 20c, 20d, the retaining hooks extending toward housing shells 16, 18 and being capable of sliding on a slightly beveled ramp of segment recesses 17a, 17b, 19a, 19b when bearing sleeve 22 is slipped onto the front of assembled housing shells 16, 18 and transmission housing 14 in a sliding fit. A snap-in mechanism is also feasible. Transmission housing 14 with openings 15a, 15b, 15c, 15d can be die cast without requiring any further machining.

In a preferred embodiment, two retaining means 20a, 20b and 20c, 20d are provided for each butt seam 37, 38, the retaining means being located symmetrical to a parting plane 27 of housing shells 16, 18. Retaining means 20a, 20b, 20c, 20d are each offset by 90° and are located at a 45° angle from butt seam 37, 38.

Bearing sleeve 22 has, at least on a front side 40, a circumferential opening 41 that supports spring action of retaining means 20a, 20b, 20c, 20d and makes it easier to slide bearing sleeve 22 with its retaining means 20a, 20b, 20c, 20d onto housing shells 16, 18.

Bearing sleeve 22 is retained axially by a common commercial snap ring 31 and is secured against a sealing ring 28 designed as an O-ring and a sintered bearing 30. Bearing sleeve 22 is seated, non-rotatably, with its retaining means 20a, 20b, 20c, 20d configured as cantilever arms in transmission housing 14. A sealing ring 32 pressed fixedly into bearing sleeve 22 is therefore also seated in a non-rotatable manner. By way of a tooth system 23 on bearing sleeve 22, formed on a transmission-side end 42, which engages in a tooth system 29 on anterior sintered bearing 30, the sintered bearing is also non-rotatably secured, which is particularly favorable for rotary hammers.

To further clarify the arrangement, FIG. 3 shows a top view of one of the retaining hooks 21 of one of the retaining means 20a of bearing sleeve 22. The bearing sleeve is located in the sliding fit on housing shells 16, 18, of which only one housing shell 16 is visible, and engages in a segment recess 17 a, retaining means 20a designed as a cantilever arm extending through a recess 15a in the transmission housing.

It will be understood that each of the elements described above, or two or more together, may also find a useful application in other types of constructions differing from the types described above.

While the invention has been illustrated and described as embodied in a housing, fastening device for a housing, and hand-held power tool with a housing, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A housing, comprising at least one housing shell enclosing an interior space and having two edges abutting each other at at least one butt seam extending axially along a longitudinal axis; and first and second retaining means provided on either side of said butt seam and acting on a particular side of said at least one housing shell on both sides of said butt seam with a force that is directed substantially radially toward said interior space.

2. A housing as defined in claim 1, wherein said retaining means clamp at least one housing shell on at least one housing front side and are located at both sides of said butt seam, said retaining means pointing from said at least one housing shell toward said interior space.

3. A housing as defined in claim 2, wherein said retaining means bear against a housing interior side in a manner selected from the group consisting of a non-positive manner, a form-fit manner, and both

4. A housing as defined in claim 2, wherein said retaining means extend from a bearing sleeve located inside said at least one housing shell outwards toward said at least one housing shell.

5. A housing as defined in claim 1; and further comprising a plurality of said butt seams, and a plurality of said retaining means, wherein said retaining means being provided in a number such that at least one retaining means more than a number of said butt seams is provided.

6. A housing as defined in claim 1, wherein two said retaining means are provided for each of said butt seams.

7. A housing as defined in claim 1, wherein at least two of said housing shells are provided, said housing shells being configured such that they overlap at said butt seam.

8. A housing as defined in claim 1, wherein said housing is configured as a housing for a hand-held power tool.

9. A fastening device for a housing, comprising at least one housing shell including an interior space and having edges abutting each other at at least one butt seam extending along a longitudinal axis; and a bearing sleeve including radially outwardly projecting retaining means selected from the group consisting of hooked retaining means and claw-like retaining means and provided on a circumference of said bearing sleeve at a distance from each other.

10. A fastening device as defined in claim 9, wherein said bearing sleeve has at least one front side provided with a circumferential recess and supports spring action of said retaining means.

11. A fastening device as defined in claim 9; and further comprising a tooth system provided on an axial end of said bearing sleeve.

12. A fastening device as defined in claim 9, wherein the fastening device is formed as a fastening device for a housing of a hand-held power tool.

13. A hand-held power tool drivable in a manner selected from the group consisting of a percussive manner, a drilling manner and both, comprising a housing selected from the group consisting of a transmission housing, a motor housing, and both and enclosed by at least one housing shell having edges abutting each other at at least one butt seam which extends axially along a longitudinal axis; first and second retaining means provided on both sides of said butt seam and acting on a particular side of said housing shell on both sides of said butt seam with a force that is directed substantially radially toward an interior space.

14. A hand-held power tool as defined in claim 13, wherein said retaining means extend radially away from a bearing sleeve toward said housing.

15. A hand-held power tool as defined in claim 13, wherein said retaining means extend relative to said transmission housing in a position selected from the group consisting of extending through said transmission housing and extending over said transmission housing.

16. A hand-held power tool as defined in claim 13, wherein said retaining means have clearance between said retaining means such that, when installed on both sides of a housing front side, at least one of said butt seams is connected with said housing in a manner selected from the group consisting of a non-positive manner, a form-fit manner and both.

17. A hand-held power tool as defined in claim 14, wherein said bearing sleeve is supported non-rotatably on the housing selected from the group consisting of said transmission housing, said motor housing and both.

18. A hand-held power tool as defined in claim 14, wherein said bearing sleeve is connected non-rotatably with a sintered bearing surrounding said transmission housing or said motor housing.

19. A hand-held power tool as defined in claim 14; and further comprising a sealing ring which is pressed into said bearing sleeve on a circumference facing said transmission housing or said motor housing.

20. A hand-held power tool as defined in claim 13, wherein the hand-held power tool is a power tool selected from the group consisting of a rotary hammer, a chisel hammer, and both.
